(19) United States
(12) Patent Application Publication
(10) Pub. No.: US 2009/0295751 A1
(43) Pub. Date: Dec. 3, 2009

(54) PORTABLE ELECTRONIC DEVICE AND DISPLAY CONTROLLING METHOD

(75) Inventors: Chia-Hung Liu, Taoyuan County (TW); Jung-Chi Lai, Guishan Shiang (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/473,825

(22) Filed: May 28, 2009

(30) Foreign Application Priority Data
May 30, 2008 (TW) 097120030

(51) Int. Cl. G06F 3/041

(52) U.S. Cl. 345/173

(57) ABSTRACT

The invention provides a portable electronic device including a display unit and an operating module coupled to the display unit. The display unit is for displaying a frame including at least one first icon corresponding to a first file or a first program. The operating module includes a touch/display unit for displaying the first icon and for enabling a user to click through the first icon. When the user clicks through the first icon displayed on the touch/display unit, the portable electronic device executes the first file or the first program corresponding to the first icon.

### BACKGROUND OF THE INVENTION

1. Field of the Invention

The present invention relates generally to a portable electronic device and a display controlling method, and more particularly, the present invention relates to a portable electronic device capable of being touched and controlled through a second display unit and a display controlling method.

2. Description of the Prior Art

Notebook computers have been becoming more and more popularized. In order to develop its characters such as high mobility and space-saving, notebook computers tend to be of light weight, thin thickness, and small volume. Owing to the restriction of the volume, notebook computers have been designed to be more delicate than desktop computers.

There was no pointing device in notebook computers in the early days. However, as the development of windows software, various types of pointing devices (e.g. trackballs, track points, track pads, track boards, touch pads, pop up mice, touch pens, etc) configured to notebook computers have gradually appeared on the market to substitute for desktop mice with poor portability. Among those pointing devices mentioned above, the touch pad is the most popular and practical pointing device at present. The touch pad, a flat board disposed in front of a keyboard, is capable of sensing a user's movement thereon so as to direct a cursor's movement. Thereby, the cursor could be moved to select the required program icon to execute the program.

However, when there are several programs installed in the computer system and only one of them is required for execution, users have to carefully search for the icons representing the programs, select the icon representing the program which is required for execution and then click through the icon to execute the program. Thus, time is wasted during executing the process of searching for the icons so that the user's working schedule is affected. On the other hand, when the user is processing other programs, he/she has to suspend the present proceeding program and switch to search for the required program icons so that the on-going program and the action of searching are unable to be executed simultaneously.

In the prior art, many operating systems are provided with hot bars. Users could directly move the cursor to the hot bar and select a program icon thereon to execute a program corresponding to the program icon instead of suspending the processing program. However, when the user is processing plenty of programs, it could waste the user's time to move the cursor and then affect the user's working schedule.

On the other hand, when users want to execute two functions simultaneously (e.g. watching movies and sending a mail at the same time) while operating a computer system, users have to switch the present displaying function, or divide the frame in order to display the functions simultaneously, which causes inconvenient for operation.

### SUMMARY OF THE INVENTION

Accordingly, an aspect of the invention is to provide a portable electronic device in which an icon originally displayed on a first display unit could be quickly clicked through by means of a second display unit, and the file or the program corresponding to the icon could be further executed. Thereby, the time for a user to search icons could be effectively saved and the problems mentioned above are thus solved.

According to an embodiment, the portable electronic device of the invention includes a display unit and an operating module. The display unit is for displaying a frame, and the frame includes an icon corresponding to a file or a program. The operating module is coupled to the display unit and further includes a touch/display unit. The operating module controls the icon to be displayed on the touch/display unit. Moreover, the touch/display unit enables a user to click through the icon. When the user clicks through the icon displayed on the touch/display unit, the portable electronic device executes the file or the program corresponding to the icon.

Another aspect of the invention is to provide a portable electronic device in which an icon could be quickly clicked through by means of a second display unit and the file or the program corresponding to the icon could be further executed. Thereby, the time for a user to search icons could be effectively saved.

According to an embodiment, the portable electronic device of the invention includes a display unit and an operating module. The display unit is for displaying a frame. The operating module is coupled to the display unit and further includes a touch/display unit. The operating module controls the touch/display unit to display an icon corresponding to a file or a program. Moreover, the touch/display unit enables a user to click through the icon. When the user clicks through the icon, the portable electronic device executes the file or the program corresponding to the icon.

Another aspect of the invention is to provide a display controlling method which could be used for controlling a display mode of a portable electronic device. An icon originally displayed on a first display unit of the portable electronic device could be quickly clicked through by means of a second display unit, and the file or the program corresponding to the icon could be further executed.

According to an embodiment, the display controlling method includes the following steps: firstly, a frame is displayed on the display unit of the portable electronic device, wherein the frame includes an icon corresponding to a file or a program; subsequently, the icon is controlled to be displayed on the touch/display unit of the portable electronic device; finally, when the icon displayed on the touch/display unit is clicked through by a user, the file or the program corresponding to the icon is executed.

Another aspect of the invention is to provide a display controlling method which could be used for controlling a display mode of a portable electronic device. An icon could be quickly clicked through by means of a second display unit, and the file or the program corresponding to the icon could be further executed.

According to an embodiment, the display controlling method includes the following steps: firstly, a frame is displayed on the display unit of the portable electronic device; subsequently, an icon corresponding to a file or a program is displayed on the touch/display unit of the portable electronic device; finally, when the icon displayed on the touch/display unit is clicked through by a user, the file or the program corresponding to the icon is executed.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a portable electronic device according to an embodiment of the invention.

FIG. 2A illustrates a frame displayed on a display unit in FIG. 1.

FIG. 2B illustrates a first icon displayed on a touch/display unit in FIG. 2A.

FIG. 3 is a flow chart demonstrating a display controlling method according to an embodiment of the invention.

FIG. 4 is a flow chart demonstrating a display controlling method according to another embodiment of the invention.

FIG. 5 is a flow chart demonstrating a display controlling method according to another embodiment of the invention.

FIG. 6 is a flow chart demonstrating a display controlling method according to another embodiment of the invention.

### DETAILED DESCRIPTION OF THE INVENTION

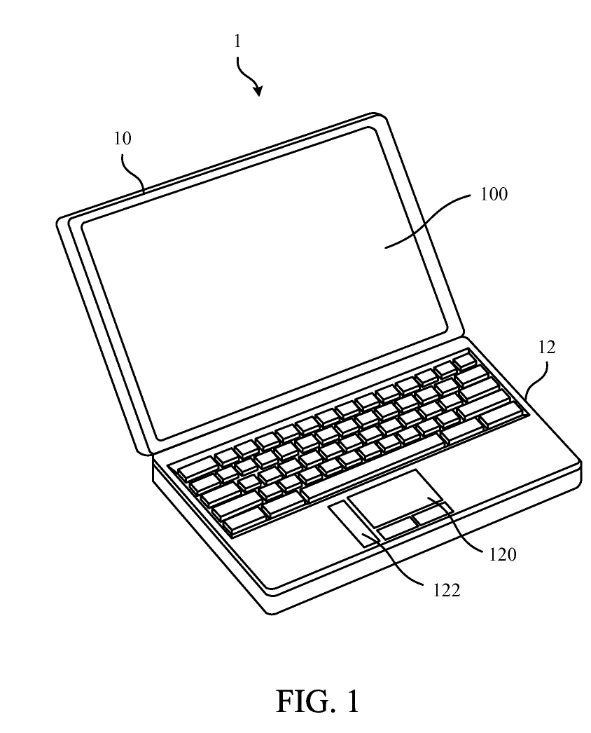

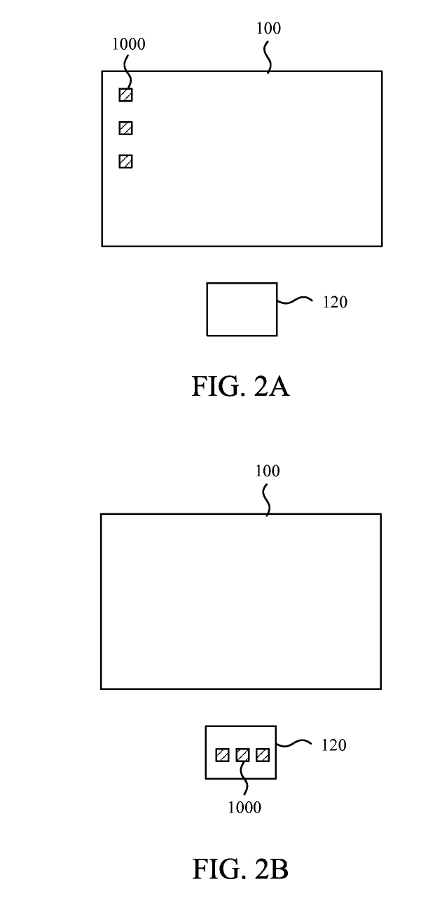

Please refer to FIG. 1, FIG. 2A and FIG. 2B. FIG. 1 illustrates a portable electronic device 1 according to an embodiment of the invention; FIG. 2A illustrates a frame 100 displayed on a display unit 10 in FIG. 1; FIG. 2B illustrates a first icon 1000 displayed on a touch/display unit 120 in FIG. 2A. As illustrated in FIG. 1, the portable electronic device 1 includes the display unit 10 and an operating module 12. The operating module 12 is coupled to the display unit 10 and further includes a touch/display unit 120. In practical applications, the portable electronic device 1 could be, but not limited to, a notebook computer.

As illustrated in FIG. 2A, the display unit 10 in the embodiment could be used for displaying a frame 100, and the frame 100 includes a first icon 1000 corresponding to a first file or a first program (not shown in the figure). Please notice that there are only three first icons 1000 shown in the figure; however, the frame 100 could include one or plural first icons 1000 in practical applications, and the number of the icons is based upon users' or designers' needs. Subsequently, as illustrated in FIG. 2B, the operating module 12 could control the first icon 1000 to be displayed on the touch/display unit 120. Moreover, the touch/display unit 120 enables a user to click through the first icon 1000. Please notice that the appearance of the first icon 1000 displayed on the touch/display unit 120 is the same as that displayed on the frame 100 in the embodiment. However, the first icon 1000 displayed on the touch/display unit 120 could have, but not limited to, a different appearance in practical applications, and what is required is to enable the user to recognize the first icon 1000 and its corresponding file or program.

In practical applications, the number and the category of the first icon 1000 displayed on the touch/display unit 120 could be determined by an individual or a designer. Furthermore, when the touch/display unit 120 displays the first icon 1000, the display unit 10 could simultaneously display the first icon 1000 or stop displaying the first icon 1000; namely, the portable electronic device 1 could be designed to display the first icon 1000 on the touch/display unit 120 instead of the display unit 10, or to display the first icon 1000 on both of them.

In practical applications, the touch/display unit 120 could be, but not limited to, a notebook computer. Thereby, the user could click through the first icon 1000 by means of touching the touch/display unit 120. When the user clicks through the first icon 1000 displayed on the touch/display unit 120, the portable electronic device 1 executes the first file or the first program corresponding to the first icon. In practical applications, the first program could be a multimedia broadcasting program, a navigation program, an immediate communicating program, an e-mail receiving/transmitting program, a file database system program, an agenda program, or an appointment reminding program.

In the embodiment, the operating module 12 further includes a hotkey 122, and the hotkey 122 could be disposed on, but not limited to, any suitable position in practical applications. When the user presses the hotkey 122, the operating module 12 could control the first icon 1000 to be displayed on the touch/display unit 120 and to enable the user to touch through it. On the other hand, if user presses the hotkey 122 again while the touch/display unit 120 is displaying the first icon 1000, the operating module 12 could control the touch/display unit 120 to stop displaying the first icon 1000. In practical applications, the user could click through a menu on the display unit 10 by the operating module 12 or the voice control to control the touch/display unit 120 to display or to stop displaying the first icon 1000. The controlling method is not limited to pressing the hotkey mentioned in the embodiment.

In the embodiment, when the user clicks through the first icon 1000 on the touch/display unit 120, the portable electronic device 1 could execute the first file or the first program corresponding to the first icon 1000 and display a first frame corresponding to the first file or the first program (e.g. the interface of Microsoft program or Outlook program) on the display unit 10.

According to another embodiment, when the user presses the hotkey 122, the touch/display unit 120 will display a main menu firstly so that users could control the first icon 1000 to be displayed on the touch/display unit 120 by means of the main menu. Furthermore, the main menu is also provided with functions for controlling the touch/display unit 120 to display at least a second icon, wherein the second icon is corresponding to a second file or a second program. When the user clicks through the second icon on the touch/display unit 120, the portable electronic device 1 could then execute the second file or the second program corresponding to the second icon and display a second frame corresponding to the second file or the second program on the touch/display unit 120. Similarly, the second program could be a multimedia broadcasting program, a navigation program, an immediate communicating program, an e-mail receiving/transmitting program, a file database system program, an agenda program, or an appointment reminding program in practical applications.

Please notice that the first frame corresponding to the first file or the first program could also be displayed on the display unit 10, and the second frame corresponding to the second file or the second program could also be displayed on the touch/display unit 120, but not limited to the embodiment mentioned above.

Moreover, in the embodiment mentioned above, when the touch/display unit 120 displays the main menu, the first icon 1000 and the second icon, the touch/display unit 120 enables the user to click through the first icon 1000 and the second icon (meanwhile, the cursor on the frame displayed on the display unit 10 is difficultly controlled). Therefore, according to another embodiment, when the touch/display unit 120 is displaying the main menu, the first icon 1000, the second icon, the first frame, or the second frame, the portable electronic device 1 could be further connected to an external inputting unit such as a mouse to control the cursor. (The external inputting unit is not limited to the example mentioned above.) Additionally, according to another embodiment, when the portable electronic device 1 is connected to the external inputting unit to control the cursor, the first icon 1000, the second icon, the first frame and the second frame could be displayed on the touch/display unit 120.

According to another embodiment, when a user presses the hotkey 122, the touch/display unit 120 could display the second icon directly for the user to click through to execute the second file or the second program corresponding to the second icon.

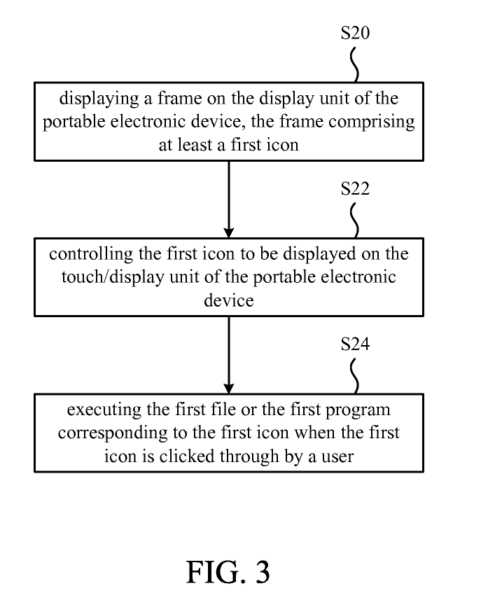

Please refer to FIG. 3. FIG. 3 is a flow chart demonstrating a display controlling method according to an embodiment of the invention. The display controlling method of the embodiment is for controlling a display mode of a portable electronic device. As illustrated in FIG. 3, the display controlling method includes the following steps: in step S20, a frame is displayed on the display unit of the portable electronic device, wherein the frame includes at least a first icon corresponding to a first file or a first program; in step S22, the first icon is controlled to be displayed on the touch/display unit of the portable electronic device; and in step S24, when the first icon displayed on the touch/display unit is clicked through by a user, the first file or the first program corresponding to the first icon is executed.

In practical applications, the portable electronic device could be a notebook computer. Similarly, the display unit could be a display panel of the notebook computer, and the touch/display unit could be a touch panel of the notebook computer. Moreover, the number and the category of the first icon displayed on the touch/display unit could be determined by users or designers.

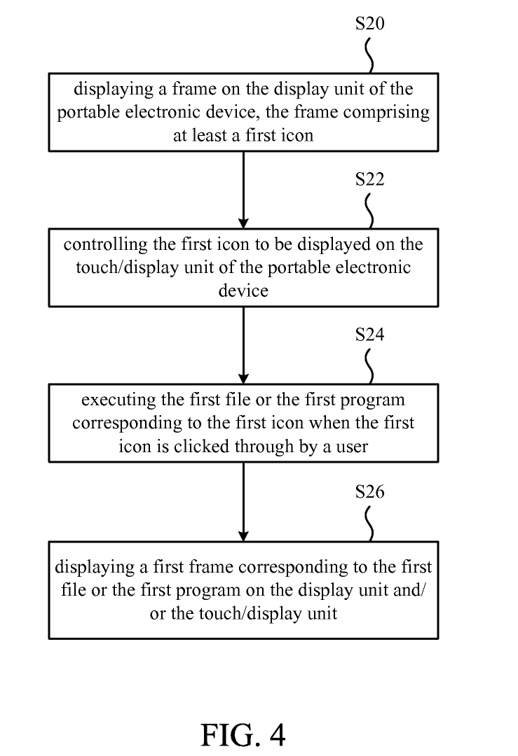

Please refer to FIG. 4. FIG. 4 is a flow chart demonstrating a display controlling method according to another embodiment of the invention. As illustrated in FIG. 4, the difference between the present embodiment and the previous one is that the display controlling method of the present embodiment further includes the following step: in step S26, a first frame corresponding to the first file or the first program is displayed on the display unit and/or the touch/display unit. For example, when the user clicks through the shortcut (the first icon) corresponding to a multimedia file (the first program) on the touch/display unit, the portable electronic device executes the multimedia program to broadcast the multimedia file and display the icon of the multimedia file (the first frame) on the touch/display unit. The other steps of the present embodiment are the same as corresponding steps in the previous embodiment, so the details are not described again here.

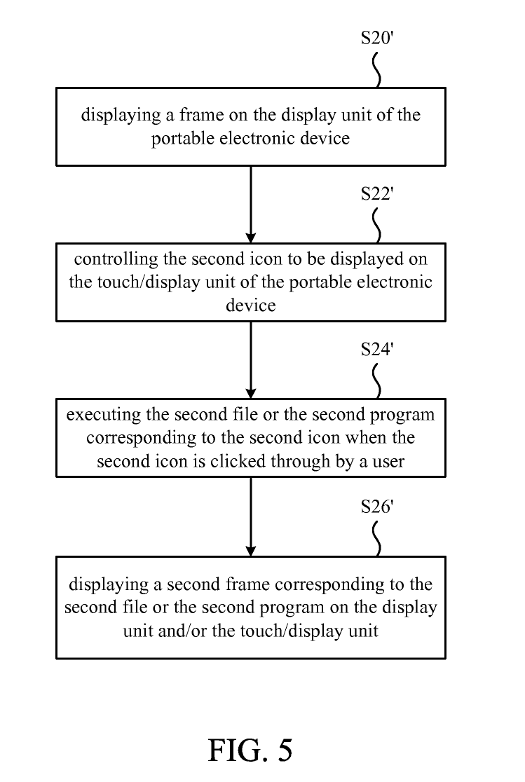

Please refer to FIG. 5. FIG. 5 is a flow chart demonstrating a display controlling method according to another embodiment of the invention. The display controlling method of the embodiment is for controlling a display mode of a portable electronic device. As illustrated in FIG. 5, the display controlling method includes the following steps: in step S20′, a frame is displayed on the display unit of the portable electronic device; in step S22′, the second icon is controlled to be displayed on the touch/display unit of the portable electronic device; in step S24, when the second icon displayed on the touch/display unit is clicked through by a user, the second file or the second program corresponding to the second icon is executed; and in step S26′, a second frame corresponding to the second file or the second program is displayed on the display unit and/or the touch/display unit.

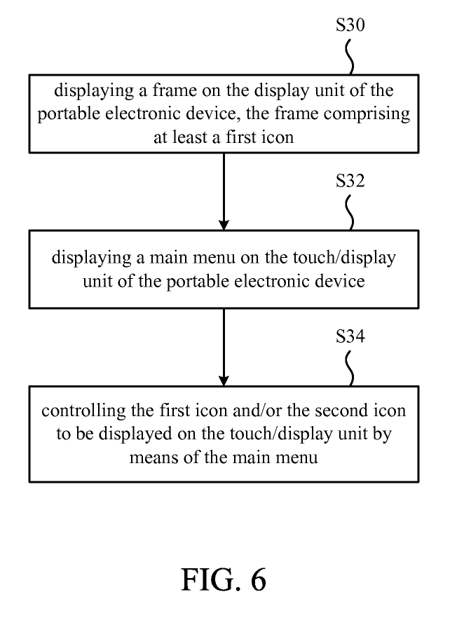

Please refer to FIG. 6. FIG. 6 is a flow chart demonstrating a display controlling method according to another embodiment of the invention. The display controlling method of the embodiment is for controlling a display mode of a portable electronic device. As illustrated in FIG. 6, the display controlling method includes the following steps: in step S30, a frame is displayed on the display unit of the portable electronic device, wherein the frame includes at least a first icon corresponding to a first file or a first program; in step S32, a main menu is displayed on the touch/display unit of the portable electronic device; and in step S34, the first icon and/or the second icon is controlled to be displayed on the touch/display unit of the portable electronic device by means of the main menu.

In practical applications, after the step S34, the user could click through the first icon or the second icon on the touch/display unit to control the portable electronic device to execute the first file or the first program corresponding to the first icon or execute the second file or the second program corresponding to the second icon, and display the corresponding first frame and/or second frame on the display unit and/or the touch/display unit.

Compared to the prior art, the portable electronic device of the present invention displays a program icon representing a program or a file, originally displayed on the display unit (e.g. an LCD) of the portable electronic device, on the touch/display unit (e.g. a touch panel with displaying function) thereon, and the touch/display unit enables the user to click through the program icon displayed on the touch/display unit to control the portable electronic device to execute the corresponding program. On the other hand, the touch/display unit could also display other customized program icons for the user to click through. Additionally, after the user clicks through the program icon on the touch/display unit and the portable electronic device executes the corresponding file or program, the touch/display unit could also display a frame corresponding to the program so as to meet the outcome of displaying on both the display unit and the touch/display unit at the same time.

Although the present invention has been illustrated and described with reference to the preferred embodiment thereof, it should be understood that it is in no way limited to the details of such embodiment but is capable of numerous modifications within the scope of the appended claims.

What is claimed is:

1. A portable electronic device comprising:
a display unit for displaying a frame, the frame comprising at least a first icon corresponding to a first file or a first program; and
an operating module coupled to the display unit, the operating module comprising a touch/display unit, the operating module controlling the first icon to be displayed on the touch/display unit, and the touch/display unit enabling a user to click through the first icon;
wherein when the user clicks through the first icon on the touch/display unit, the portable electronic device executes the first file or the first program corresponding to the first icon.

2. The portable electronic device of claim 1, wherein the first file or the first program has a corresponding first frame displayed on the display unit and/or the touch/display unit.

3. The portable electronic device of claim 1, wherein the touch/display unit displays a main menu.

4. The portable electronic device of claim 3, wherein the operating module further comprises a hotkey, and the touch/display unit is controlled to display/close the main menu by means of the hotkey.

5. The portable electronic device of claim 3, wherein the main menu enables the user to control the first icon to be displayed on the touch/display unit.

6. The portable electronic device of claim 3, wherein the main menu enables the user to control the touch/display unit to display at least a second icon corresponding to a second file or a second program, and the touch/display unit enables the user to click through the second icon; when the user clicks through the second icon on the touch/display unit, the portable electronic device executes the second file or the second program corresponding to the second icon.

7. The portable electronic device of claim 6, wherein the second program comprises at least one selected from a group consisting of a multimedia broadcasting program, a navigation program, an immediate communicating program, an e-mail receiving/transmitting program, a file database system program, an agenda program, and an appointment reminding program.

8. The portable electronic device of claim 1 further comprising:
an external inputting unit for controlling a cursor displayed on the frame;
wherein when the portable electronic device is connected to the external inputting unit, the first icon of the frame is displayed on the touch/display unit.

9. A portable electronic device comprising:
a display unit for displaying a frame; and
an operating module coupled to the display unit, the operating module comprising a touch/display unit, the operating module controlling the touch/display unit to display a first icon corresponding to a first file or a first program, and the touch/display unit enabling a user to click through the first icon;
wherein when the user clicks through the first icon on the touch/display unit, the portable electronic device executes the first file or the first program corresponding to the first icon.

10. The portable electronic device of claim 9, wherein the first file or the first program has a corresponding first frame displayed on the display unit and/or the touch/display unit.

11. The portable electronic device of claim 9, wherein the first program comprises at least one selected from a group consisting of a multimedia broadcasting program, a navigation program, an immediate communicating program, an e-mail receiving/transmitting program, a file database system program, an agenda program, and an appointment reminding program.

12. The portable electronic device of claim 9, wherein the touch/display unit displays a main menu.

13. The portable electronic device of claim 12, wherein the operating module further comprises a hotkey, and the touch/display unit is controlled to display/close the main menu by means of the hotkey.

14. The portable electronic device of claim 12, wherein the main menu enables the user to control the touch/display unit to display the first icon.

15. The portable electronic device of claim 12, wherein the frame comprises at least a second icon corresponding to a second file or a second program, the operating module controls the second icon to be displayed on the touch/display unit, and the touch/display unit enables the user to click through the second icon; when the user clicks through the second icon on the touch/display unit, the portable electronic device executes the second file or the second program corresponding to the second icon.

16. The portable electronic device of claim 9 further comprising:
an external inputting unit for controlling a cursor displayed on the frame;
wherein when the portable electronic device is connected to the external inputting unit, the operating module controls the touch/display unit to display the first icon.

17. A display controlling method, for controlling a display mode of a portable electronic device, the portable electronic device comprising a display unit and a touch/display unit, the display controlling method comprising the following steps:
(a) displaying a frame on the display unit, the frame comprising at least a first icon corresponding to a first file or a first program;
(b) controlling the first icon to be displayed on the touch/display unit; and
(c) when the first icon displayed on the touch/display unit is clicked through by a user, executing the first file or the first program corresponding to the first icon.

18. The display controlling method of claim 17 further comprising the following step:
(d) displaying a first frame corresponding to the first file or the first program on the display unit and/or the touch/display unit.

19. The display controlling method of claim 17 further comprising the following step:
(e) displaying a main menu on the touch/display unit.

20. The display controlling method of claim 19, wherein the main menu enables the user to control the first icon to be displayed on the touch/display unit.

21. The display controlling method of claim 19, wherein the main menu enables the user to control the touch/display unit to display at least a second icon corresponding to a second file or a second program, and the touch/display unit enables the user to click through the second icon; when the user clicks through the second icon displayed on the touch/display unit, the display controlling method further comprises the following step:
(f) executing the second file or the second program corresponding to the second icon.

22. The display controlling method of claim 21, wherein the second program comprises at least one selected from a group consisting of a multimedia broadcasting program, a navigation program, an immediate communicating program, an e-mail receiving/transmitting program, a file database system program, an agenda program, and an appointment reminding program.

23. A display controlling method, for controlling a display mode of a portable electronic device, the portable electronic device comprising a display unit and a touch/display unit, and the display controlling method comprising the following steps:
(a) displaying a frame on the display unit;
(b) controlling the touch/display unit to display a first icon corresponding to a first file or a first program; and
(c) when the first icon displayed on the touch/display unit is clicked through by a user, executing the first file or the first program corresponding to the first icon.

24. The display controlling method of claim 23 further comprising the following step:
(d) displaying a first frame corresponding to the first file or the first program on the display unit and/or the touch/display unit.

25. The display controlling method of claim 23, wherein the first program comprises at least one selected from a group consisting of a multimedia broadcasting program, a navigation program, an immediate communicating program, an e-mail receiving/transmitting program, a file database system program, an agenda program, and an appointment reminding program.

26. The display controlling method of claim 23 further comprising the following step:
(e) displaying a main menu on the touch/display unit.

27. The display controlling method of claim 26, wherein the main menu enables the user to control the touch/display unit to display the first icon.

28. The display controlling method of claim 26, wherein the frame comprises at least a second icon corresponding to a second file or a second program, and when the user clicks through the second icon displayed on the touch/display unit, the display controlling method further comprising the following step:
(f) executing the second file or the second program corresponding to the second icon.
